(19) United States
(12) Patent Application Publication
(10) Pub. No.: US 2011/0264793 A1
(43) Pub. Date: Oct. 27, 2011

(54) Capturing Internet Content

(76) Inventors: Jason D. Goldman, Fort Collins, CO (US); Philip M. Walker, Fort Collins, CO (US); Charles M. McJilton, Longmont, CO (US)

(21) Appl. No.: 12/997,273

(22) PCT Filed: Jul. 31, 2008
(86) PCT No.: PCT/US08/71723

§ 371 Date: Feb. 2, 2011

(51) Int. Cl. G06F 15/173

(52) U.S. Cl. 709/224

(57) ABSTRACT

A method and system for capturing digital content that is accessible at predetermined times from the Internet is herein disclosed. At least one embodiment of a method includes receiving data related to scheduled Internet content and providing at least a portion of the received Internet data as a schedule, the schedule including one or more content listings corresponding to the scheduled Internet content. Some embodiments include, in response to receiving a selection of at least one of the listings, scheduling a recording of the corresponding Internet content.

### BACKGROUND

As the Internet has become a greatly utilized communications medium for the transmission of digital data, users have demanded greater functionality to access this digital data. More specifically, as digital audio, digital video, digital images, digital data, digital content is available for viewing, users have demanded a greater ability to access this data. As a nonlimiting example, oftentimes Internet radio transmissions, video transmissions, webinars, etc., are broadcast at predetermined times on the Internet via an audio and/or video stream, and a user may be unable to view the presentation at the broadcasted time. Similarly, some content may be archived as static content at a website (being transient in availability), but the archive may only store the content for a short amount of time. There is a need for a mechanism to capture such digital content for longer availability.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

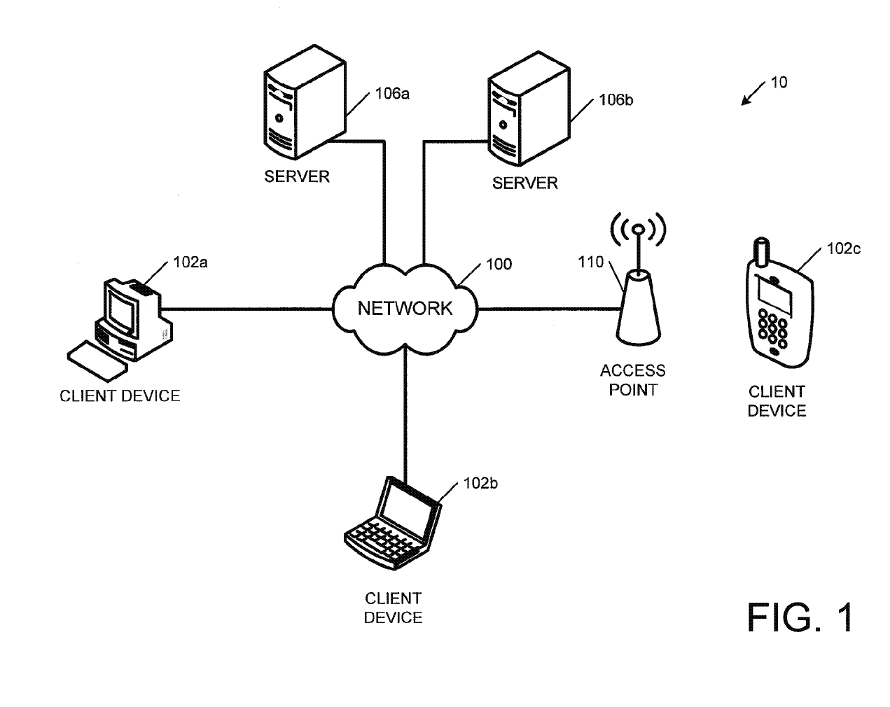

FIG. 1 illustrates an exemplary embodiment of a communications network, which may be configured to facilitate communication of data.

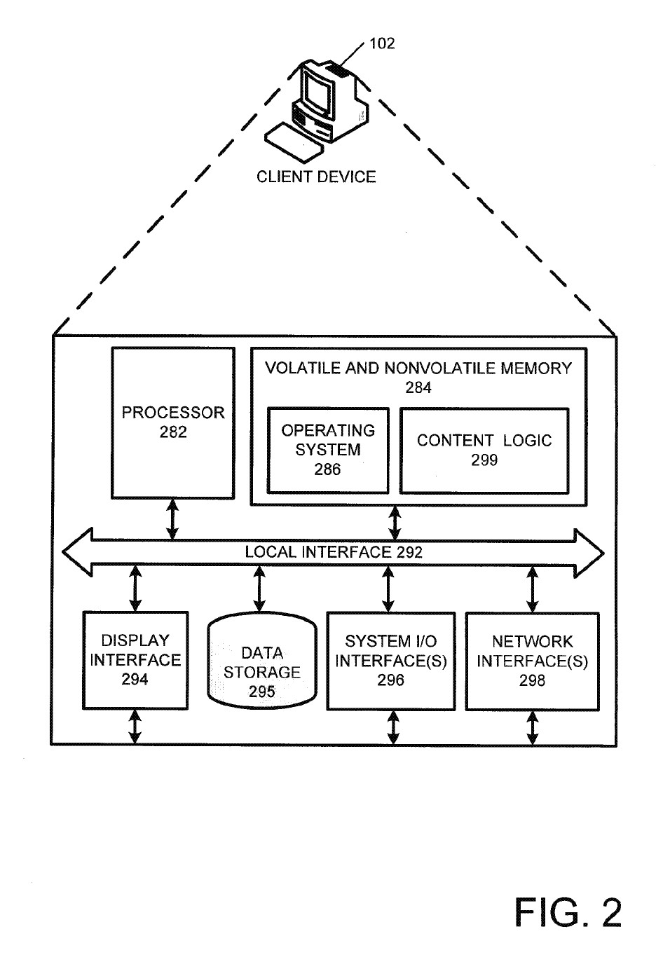

FIG. 2 illustrates an exemplary embodiment of a client device 102, which may be configured to provide options for uploading and/or downloading content, such as in the network from FIG. 1.

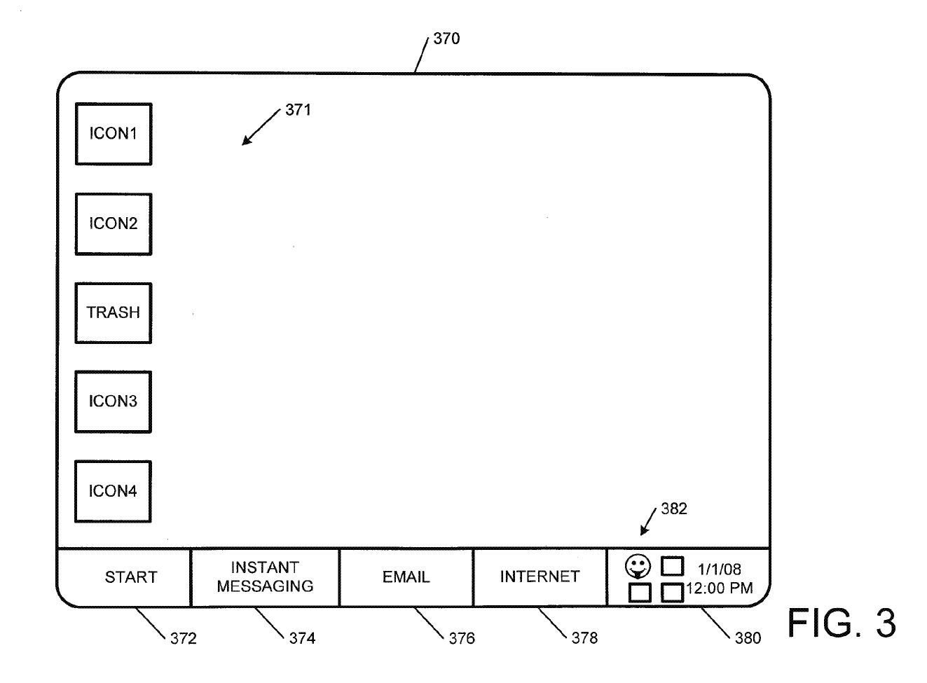

FIG. 3 illustrates an exemplary embodiment of a user interface for providing one or more applications, such as on the client device from FIG. 2.

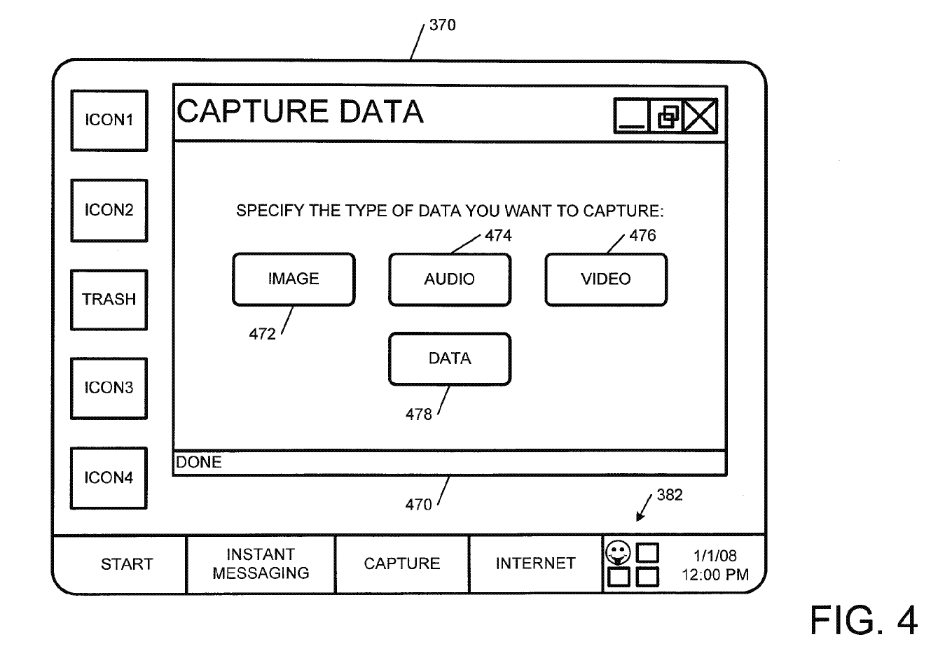

FIG. 4 illustrates an exemplary embodiment of a user application interface for capturing Internet data, displayed with the interface from FIG. 3.

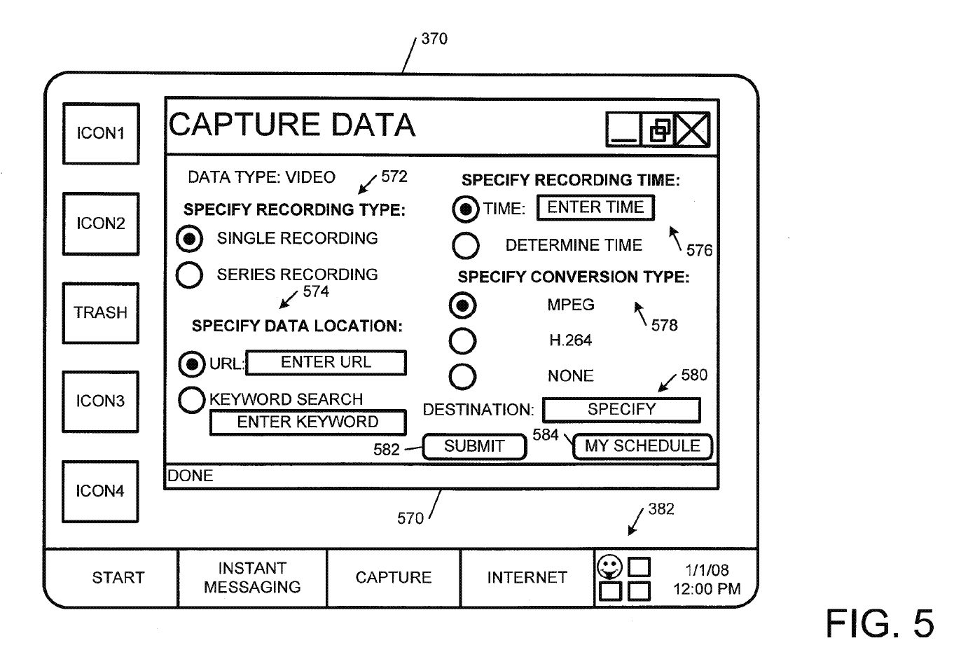

FIG. 5 illustrates an exemplary embodiment of an options interface, further depicting one or more data capture options, similar to the diagram from FIG. 4.

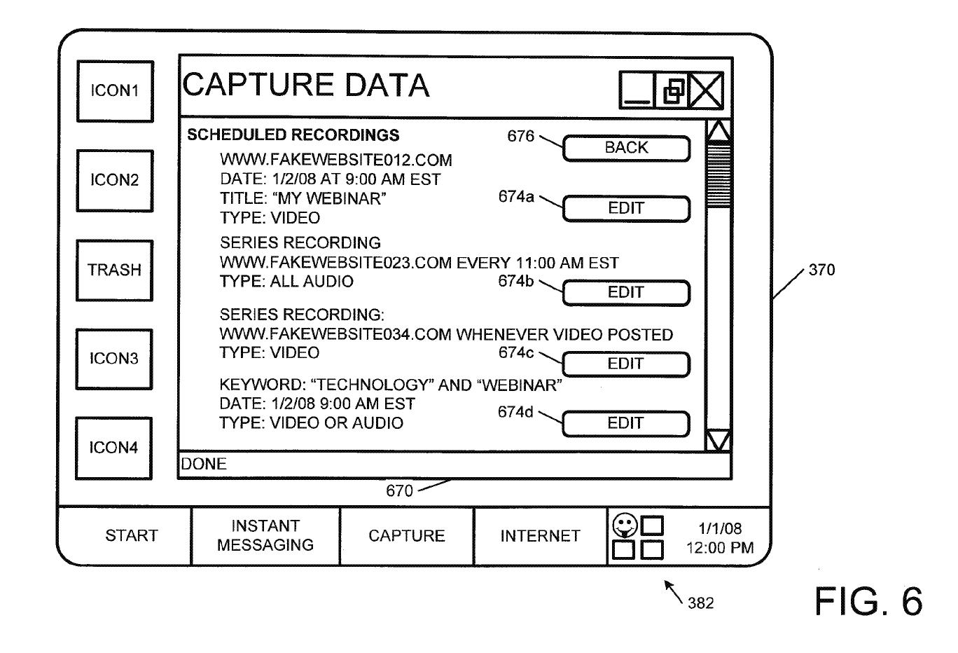

FIG. 6 illustrates an exemplary embodiment of a schedule interface, further depicting one or more scheduled recordings, similar to the diagram from FIG. 5.

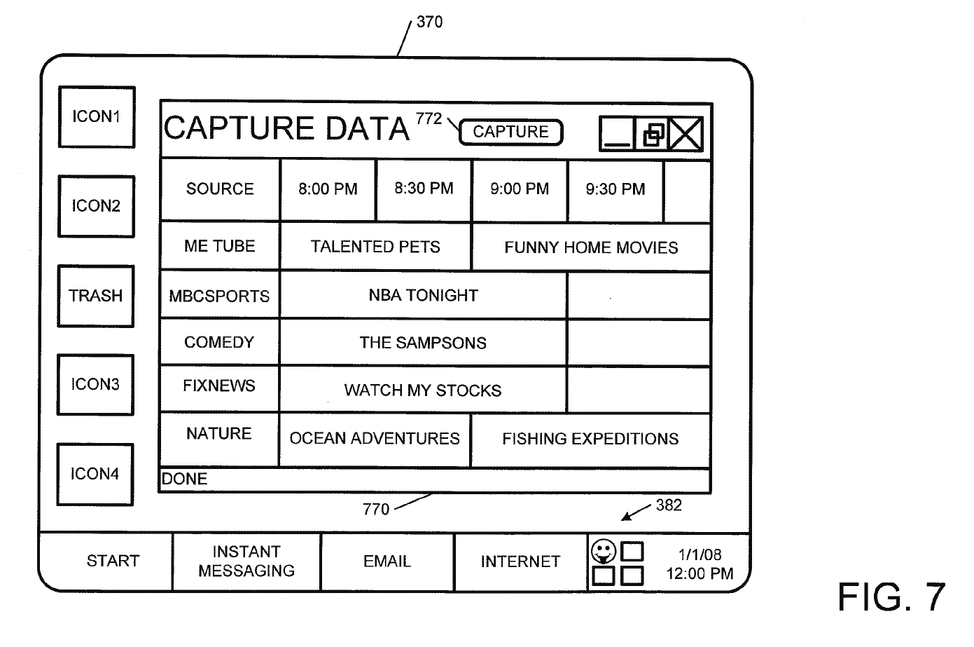

FIG. 7 illustrates an exemplary embodiment of a directory interface, further depicting a content schedule, similar to the diagram from FIG. 6.

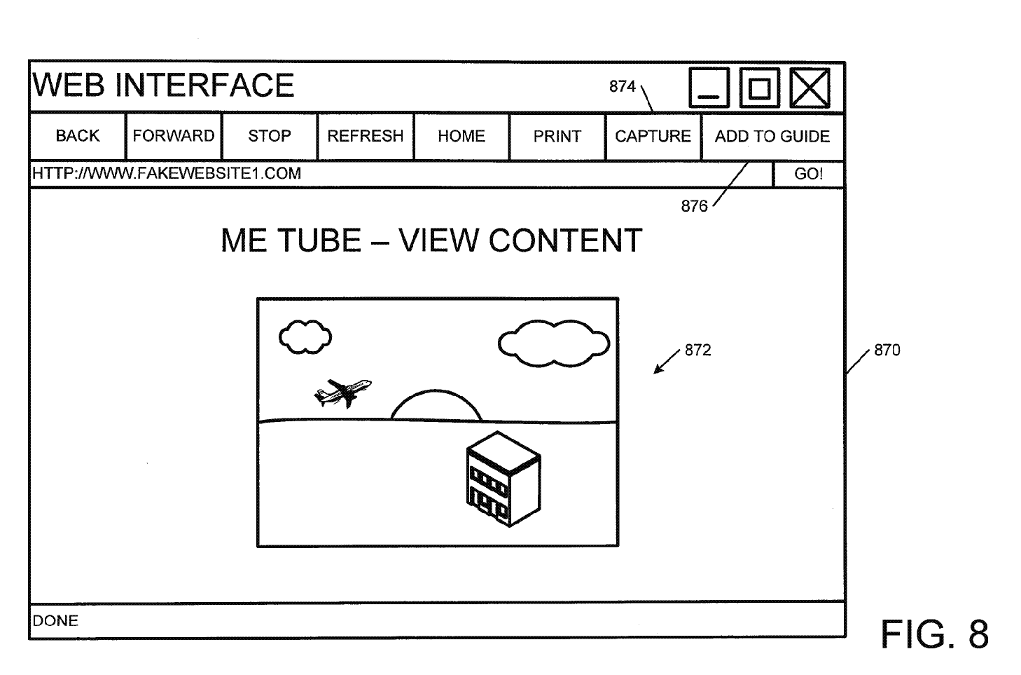

FIG. 8 illustrates an exemplary embodiment of a web interface, illustrating use of a capture option, such as may be provided by the client device from FIG. 2.

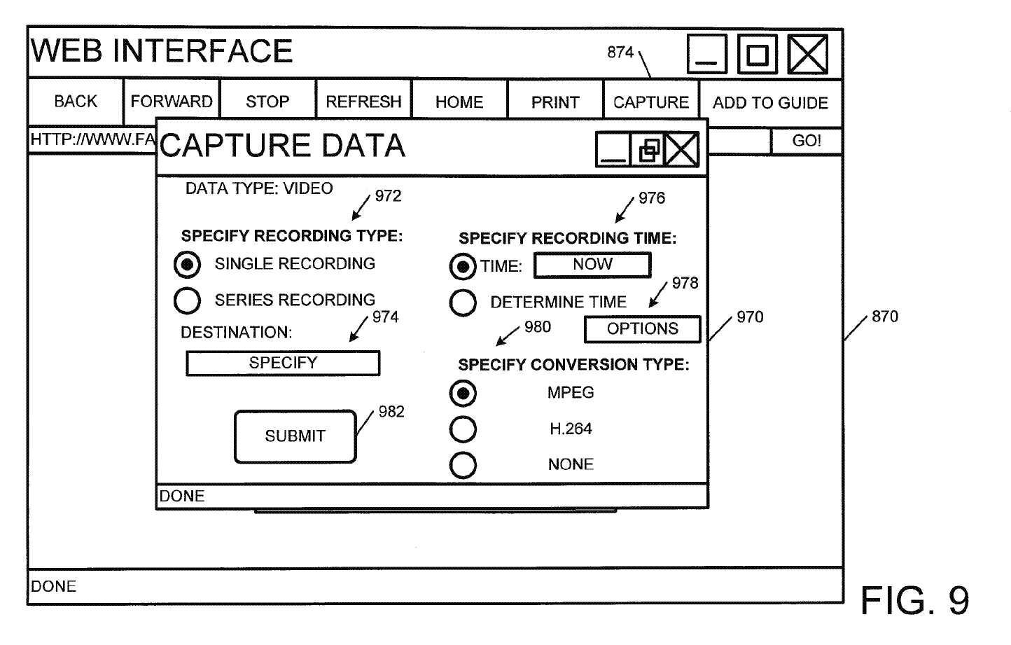

FIG. 9 illustrates an exemplary embodiment of the web interface, further depicting one or more options for capturing content, similar to the diagram from FIG. 8.

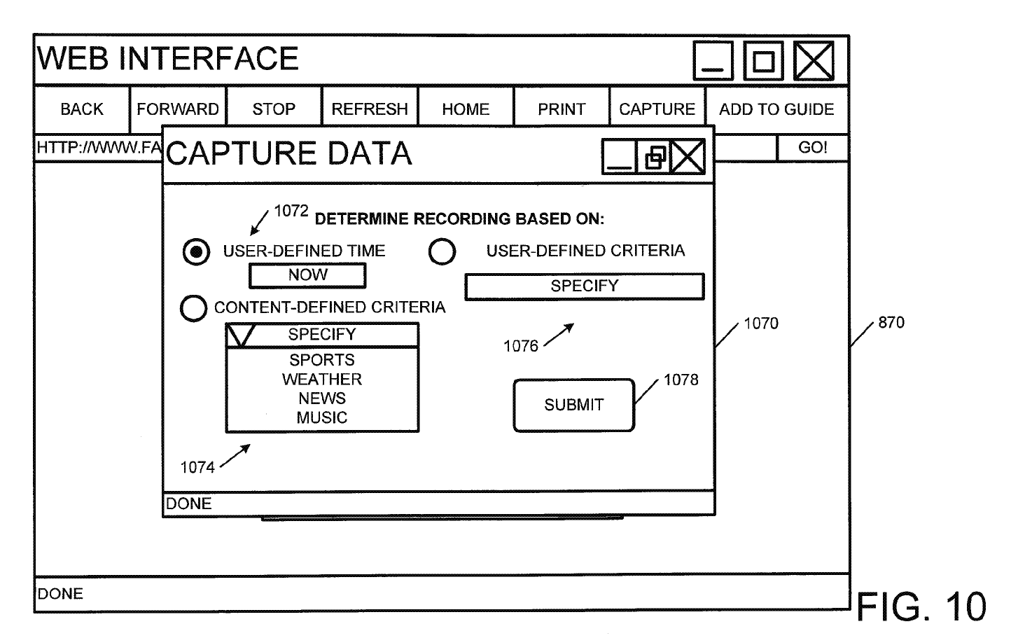

FIG. 10 illustrates an exemplary embodiment of a web interface, further depicting a time option interface, similar to the diagram from FIG. 9.

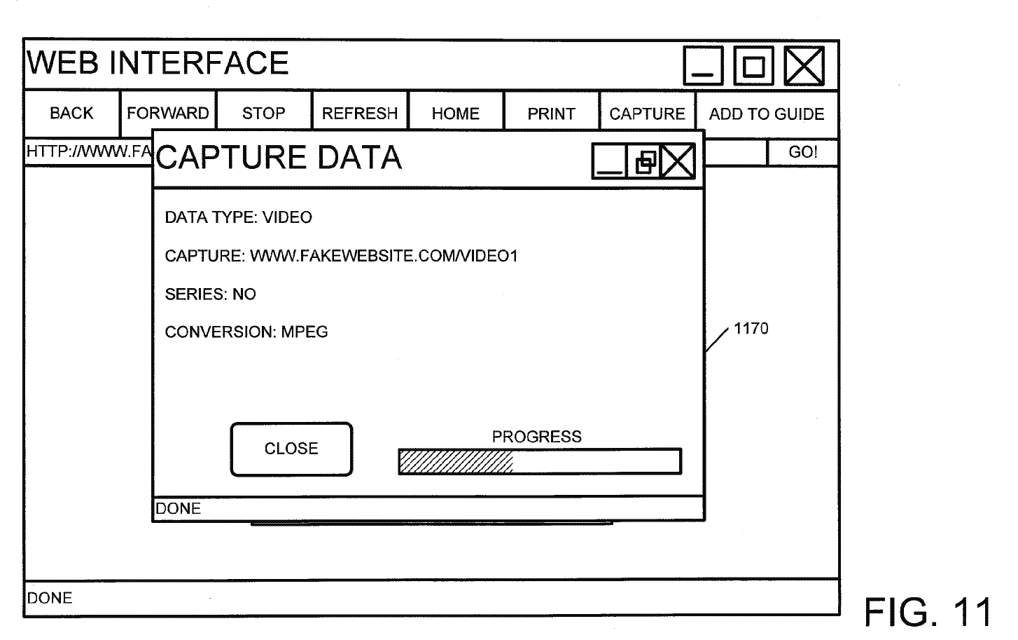

FIG. 11 illustrates an exemplary embodiment of the web interface, further depicting progress of data capture, similar to the diagram from FIG. 10.

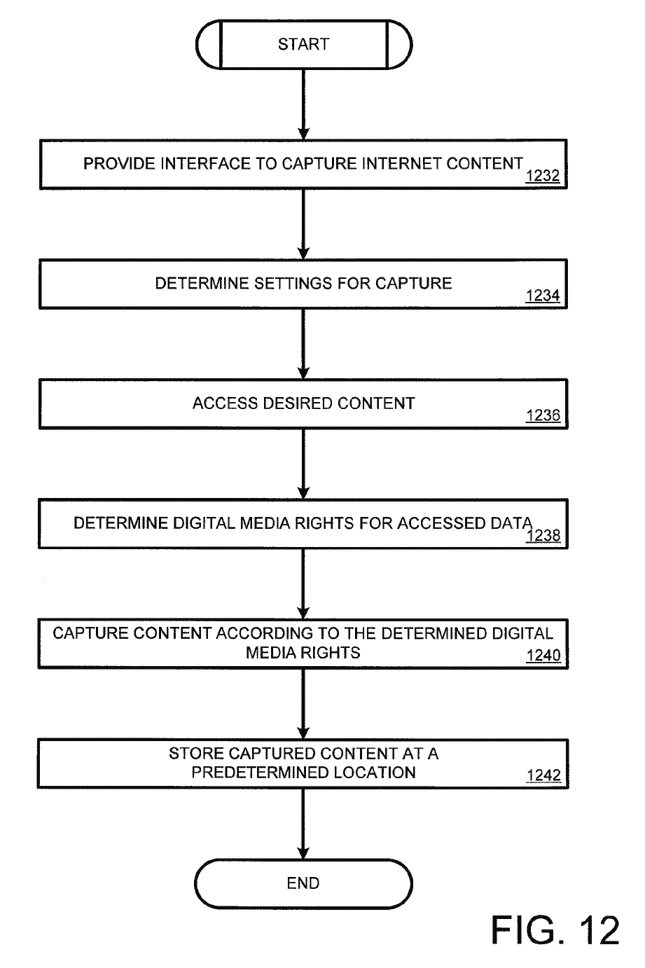

FIG. 12 illustrates an exemplary embodiment of a process that may be utilized for scheduling the capture of Internet data, such as in the network from FIG. 1.

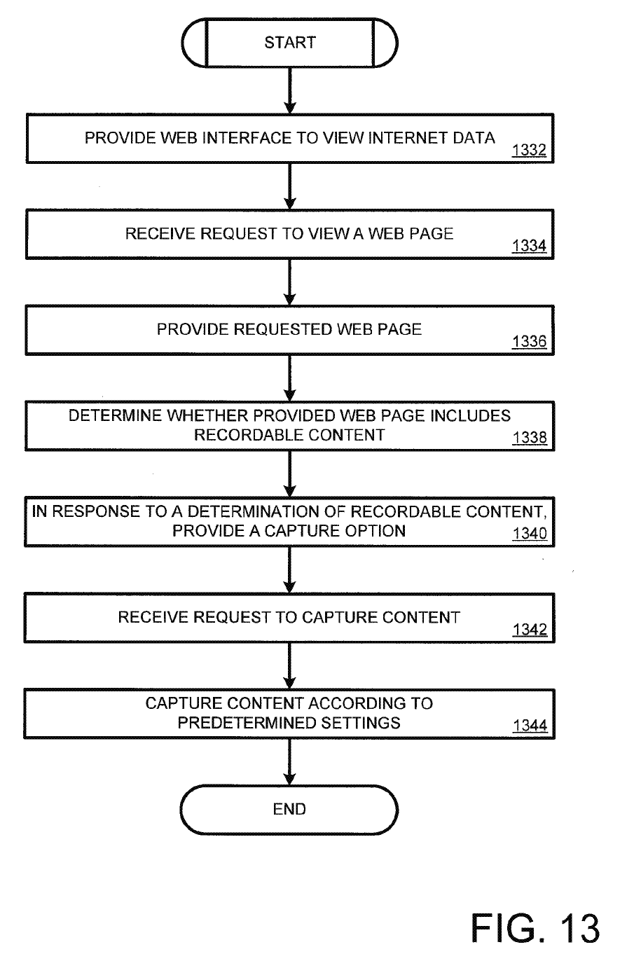

FIG. 13 illustrates an exemplary embodiment of a process that may be utilized for capturing Internet data via a web interface, similar to the diagram from FIG. 12.

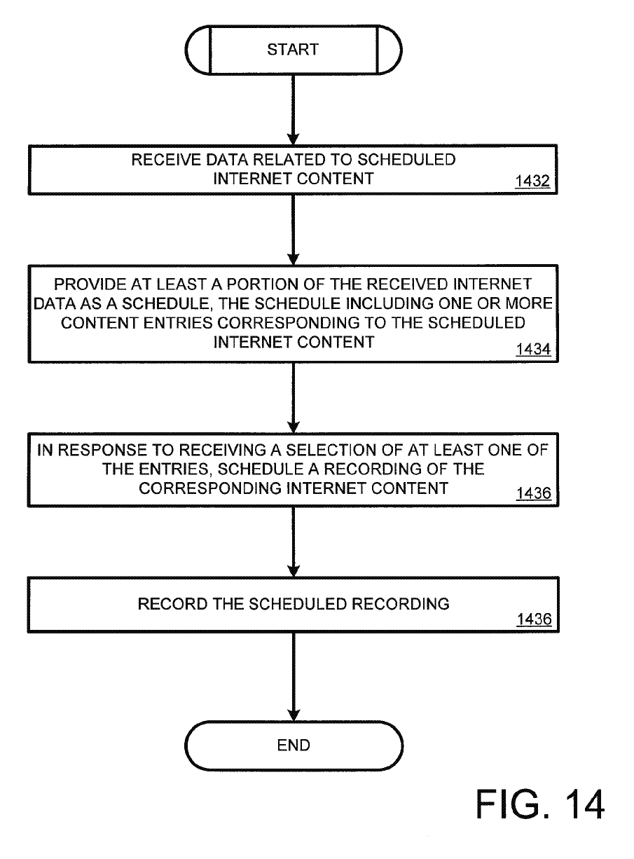

FIG. 14 illustrates an exemplary embodiment of a process that may be utilized for scheduling a recording of Internet content, similar to the diagram from FIG. 13.

### DETAILED DESCRIPTION

Currently, one method for capturing Internet content is to access archived content from a content provider. While some content providers have the capacity to archive a portion of their content, many providers do not have resources to store all content over the course of time. Similarly, users are not always interested in digging through an archive that includes dozens of archived broadcasts in order to find the content they want to access.

Embodiments of the present disclosure may be configured to operate on a personal computer, home server, storage server, personal display assistant, cell phone, notebook, handheld devices, and/or other computing devices that can access digital data from the Internet. Similarly, configuration of at least one of these embodiments may include a user defining a time period and source stream for capturing Internet data. These settings may be utilized to access the desired content at the scheduled time and store this data to memory. The recording may be formatted as a standard and/or other user-defined format. Similarly, the recording may be integrated into the user's media library, so the user can have local access and/or control of the content. The term “content” as used herein may refer to audio, video, image, and/or other data which may be provided to a user via the Internet. Content may be provided via a web page, however, this is not a requirement.

Additionally, the user may explicitly schedule a recording by entering a start time and/or date, an end time and/or date, and/or a URL to the content stream. Similarly, the interface may be configured to take advantage of a directory interface that includes listings of internet media streams arranged by name, type, and/or other criteria.

Further, as mentioned above, content may be accessed according to a predetermined schedule. Media streams may be configured to utilize any number of different media formats. Each of these formats may be associated with a particular technology for decoding the media stream and presenting it to the user. This technology can also be utilized to record the content. Once recorded, the content may be integrated the user's media library by placing the recorded content file into a desired location so that the media library management tool (e.g., iTunes and/or other management tool) can recognize and add the content to the library.

Additionally, embodiments disclosed herein may be configured to address digital rights management (DRM) for the content provider. A content provider may desire to not allow users to access or record data provided through the Internet. Accordingly, as discussed in more detail below, any number of mechanisms may be utilized to prevent and/or reduce such unwanted access.

Referring to the drawings, FIG. 1 illustrates an exemplary embodiment of a communications system 10, which may be configured to facilitate the communication and access of digital data. As illustrated in FIG. 1, there is a network 100 may be utilized and include a wide area network (WAN), such as the Internet, a public switched telephone network (PSTN), mobile communications network (MCN) and/or other network. Similarly, the network 100 may include a wireline and/or a wireless local area network (LAN). Regardless of the communications medium and protocol, the network 100 may be coupled to one or more client devices 102a, 102b, 102c. The client devices 102a, 102b, 102c (collectively referred to as “client device 102”) may include a personal computer, laptop, server, home storage device, cell phone, personal display assistant, or other device that is capable of communicating with the network 100. While the client devices 102a, 102b may be wireline devices, the client device 102c may be configured for wireless communications and be configured to communicate with the network 100 via an access point 110 or other wireless communications device.

Referring again to FIG. 1 is the access point 110. The access point 110 may be configured as a wireless cellular tower, a wireless fidelity (Wi-Fi) hotspot, a worldwide interoperability for microwave access (WIMAX) tower, and/or other wireless node.

There is shown in FIG. 1, servers 106a and 106b. The servers 106a and 106b may include web servers and/or other types of servers configured for providing content to a client device 102. More specifically, the servers 106a and/or 106b may be configured to provide image, audio, and/or video data for streaming, archiving, and/or otherwise provide and store data.

One should note that, while the diagram of FIG. 1 illustrates the servers 106a and 106b as single components, this is a nonlimiting example. More specifically, depending on the particular configuration, the servers 106a and/or 106b may include a plurality of servers, data storage components, and/or other components. Additionally, while the discussion with regard to FIG. 1 describes embodiments where content is sent via the servers 106a, 106b, this is also a nonlimiting example, as in some embodiments, the servers 106 may facilitate a communication pathway between the message sender and message recipient, but may be configured to receive only a copy of the messages sent.

FIG. 2 illustrates an exemplary embodiment of a client device 102, which may be configured to provide options for uploading and/or downloading content, such as in the system 10 from FIG. 1. Although a wire-line device (e.g., the client device 102) is illustrated, this discussion can be applied to wireless devices, as well. According to exemplary embodiments, in terms of hardware architecture, the client device 102 includes a processor 282, a memory component 284, a display interface 294, data storage 295, one or more input and/or output (I/O) device interface(s) 296, and/or one or more network interfaces 298 that are communicatively coupled via a local interface 292.

The local interface 292 can include, for example but not be limited to, one or more buses and/or other wired or wireless connections. The local interface 292 may have additional elements, which are omitted for simplicity, such as controllers, buffers (caches), drivers, repeaters, and receivers to enable communications. Further, the local interface 292 may include address, control, and/or data connections to enable appropriate communications among the aforementioned components.

The processor 282 may be an integrated circuit for executing software, particularly software stored in the memory component 284. The processor 282 can include any custom made or commercially available processor, a central processing unit (CPU), an auxiliary processor among several processors associated with the client device 102, a semiconductor based microprocessor (in the form of a microchip or chip set), a macroprocessor, and/or generally any device for executing software instructions.

The memory component 284 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory 284 may incorporate electronic, magnetic, optical, and/or other types of storage media. One should note that the memory 284 can have a distributed architecture (where various components are situated remote from one another), but can be accessed by the processor 282.

The software in the memory 284 may include one or more separate programs, which may include an ordered listing of executable instructions for implementing logical functions. In the example of FIG. 2, the software in the memory component 284 may include capture logic 299, as well as an operating system 286. The operating system 286 may be configured to control the execution of other computer programs and provides scheduling, input-output control, file and data management, memory management, and communication control and related services. The capture logic 299 may include one or more pieces of logic and may be configured to facilitate communication of Internet content, as discussed in more detail below.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the memory component 284, so as to operate properly in connection with the operating system 286.

The input/output devices that may be coupled to the system I/O Interface(s) 296 may include input devices, for example, but not limited to, a keyboard, mouse, scanner, touch screen, microphone, etc. Further, the I/O devices may also include output devices, for example but not limited to, a printer, display, speaker, etc. Finally, the I/O devices may further include devices that communicate both as inputs and outputs, for instance, but not limited to, a modulator/demodulator (modem; for accessing another device, system, or network), a radio frequency (RF) or other transceiver, a telephonic interface, a bridge, a router, etc.

Additionally included are one or more of the network interfaces 298 for facilitating communication with one or more other devices. More specifically, network interface 298 may include any component configured to facilitate a connection with another device. While in some embodiments, among others, the client device 102 can include the network interface 298 that includes a personal computer memory card international association (PCMCIA) card (also abbreviated as “PC card”) for receiving a wireless network card, this is a nonlimiting example. Other configurations can include the communications hardware within the client device 102, such that a wireless network card is unnecessary for communicating wirelessly. Similarly, other embodiments include the network interfaces 298 for communicating via a wired connection. Such interfaces may be configured with universal serial bus (USB) interfaces, serial ports, and/or other interfaces.

If the client device 102 includes a personal computer, workstation, or the like, the software in the memory 284 may further include a basic input output system (BIOS) (omitted for simplicity). The BIOS is a set of software routines that initialize and test hardware at startup, start the operating system 286, and support the transfer of data among the hardware devices. The BIOS is stored in ROM so that the BIOS can be executed when the client device 102 is activated.

When the client device 102 is in operation, the processor 282 may be configured to execute software stored within the memory component 284, to communicate data to and from the memory component 284, and to generally control operations of the client device 102 pursuant to the software. Software in the memory component 284, in whole or in part, may be read by the processor 282, perhaps buffered within the processor 282, and then executed.

FIG. 3 illustrates an exemplary embodiment of a user interface 370 for providing one or more applications, such as on the client device from FIG. 2. As illustrated in the nonlimiting example of FIG. 3, the user interface 370 may include one or more icons 371, as well as a start option 372, and instant messaging option 374, an email option 376, and an Internet option. The options 372-376 are included for purposes of illustrating that one or more foreground applications may be currently running and displayed in a taskbar of the user interface 370. Additionally, the user interface may include a taskbar portion 380, which may be configured to display the date and/or time, as well as one or more icons 382 of currently running background applications.

More specifically, a user can select an icon corresponding with the capture logic 299. This selection may prompt display of a user interface as a foreground application, as discussed in more detail below. Additionally, the icon 382 may also be displayed to indicate that the capture logic 299 is being utilized as a background application, as well. By utilizing the capture logic 299 as a background application, the capture logic 299 may be able to monitor scheduled capture times to capture the desired content according to the desired settings. Depending on the particular configuration, this configuration may allow capture of the data, even if the foreground application of capture logic 299 is currently closed.

FIG. 4 illustrates an exemplary embodiment of a user interface 470 for capturing Internet data, displayed with the interface from FIG. 3. As illustrated in the nonlimiting example of FIG. 4, upon selection of an icon associated with the capture logic 299, a data type interface 470 may be presented to the user. The data type interface may be configured to provide one or more options for a user to select the type of data to be captured. More specifically, an image option 472, an audio option 474, a video option 476, and a data option 478.

FIG. 5 illustrates an exemplary embodiment of an option interface 570, further depicting one or more data capture options, similar to the diagram from FIG. 4. As illustrated in FIG. 5, by selecting one or more of the options (e.g., options 472-478) from FIG. 4, an options interface 570 may be presented to the user for selecting one or more options for a current and/or future recording. More specifically, the option interface 570 in FIG. 5 may be presented in response to selection of the video option 476, from FIG. 4. Additionally, the options interface 570 may include a recording type option 572, a data location option 574, a recording time option 576, a conversion option 578, a destination option 580, and a submit option 582.

The recording type option 572 may be configured to determine whether the current recording is a single recording or a series recording. If the current recording is a single recording, the user can select options for a one-time recording. If however, the current recording is a series recording, the user can specify the criteria for recording a plurality of broadcasts as a series. More specifically, the user may specify that the capture logic 299 record any content that fits predetermined criteria. Such criteria can include specifying to record all content broadcast from a specified website, all content on a particular subject (without regard to source), and/or other criteria.

Similarly, the data location option 574 may be included and utilized by a user to determine the location of data to be captured. More specifically, the user can enter a uniform resource locator (URL) of the website that is providing the content. One should note that while in some embodiments, the URL may be input into the URL prompt of data location option 574, this is a nonlimiting example. However, in some embodiments, the capture logic 299 can search one or more extensions of the website input into the URL prompt to locate the desired content. Similarly, the keyword search portion of the data location option 574 may be configured to receive a keyword associated with content and perform a search of the Internet (or at least a portion of the Internet) for the desired content. As one or more search result may be found, a list of the content that matches the keyword may be presented to the user. From the list, the user may select one or more result for recording.

Also included is the recording time option 576. The recording time option may be configured for the user to enter a time to begin and/or end recording. Additionally, the recording time option 576 may be configured to determine a time to begin recording. More specifically, by specifying a data location (via a URL and/or otherwise), the capture logic 299 may be configured to determine a time that the content will broadcast and/or be provided. Additionally, in at least one exemplary embodiment, the user may be provided with an additional option to determine a segment of the content to trigger recording. Alternatively, the user may indicate a desire to record a newscast. Additionally, the user may indicate that the only portion of the newscast that the user desires for recording is the sports portion. The capture logic can then perform an analysis of the content such that recording begins at the sports portion. This analysis may include extracting metadata from the content to determine when the sports portion begins and ends and/or searching for queues within the content to determine when the sports portion begins and ends.

Also shown FIG. 5 is the conversion type option 578. The conversion option 578 may be configured to allow conversion of the content from a first format to a user-defined second format. As the content may be originally formatted according to the desires of the content provider, the user may desire to format the content in a different format. Accordingly, the user may select one or more conversion formats. Additionally, the user can determine a destination for the content. The destination may be a local drive a network drive, a URL, an IP address, an email address, an instant messaging address, an Internet protocol (IP) address, and/or other location. Upon selection of the desired options, the user may select the submit option 582 to confirm the recording. Also included is a view schedule option 584.

FIG. 6 illustrates an exemplary embodiment of the user interface 670, further depicting one or more scheduled recordings, similar to the diagram from FIG. 5. As illustrated in FIG. 6, the schedule interface 670 may be configured to provide data related to previously scheduled upcoming recordings. More specifically, a list of the recordings may be presented with an edit option 676a-676d to edit and/or delete one or more of the listed recordings. Additionally, a back option 676 may be provided to return to a previous interface.

FIG. 7 illustrates an exemplary embodiment of a directory interface 770, further depicting a content schedule, similar to the diagram from FIG. 6. As illustrated in the nonlimiting example of FIG. 7, the directory interface 770 may be configured to provide broadcast data provided by one or more content providers, such as “me tube,” “mbcsports,” “comedy,” “fixnews.” and “nature.” Additionally, a graphical representation of the beginning and ending times of the content is provided.

In addition to the content listings in the directory interface 770, a capture option 772 is also provided. More specifically, the capture option 772 may be configured such that a user can select one or more listing from the directory interface 770 and also select the capture option 772 to record the selected content. While in some embodiments, selection of the capture option 772 may automatically schedule a recording according to predetermined default settings, some embodiments may be configured to provide the options interface 570 from FIG. 5 to determine the recording options for one or more of the selected content.

In operation, the capture logic 299 may be configured to store selected web pages (and/or other addresses) corresponding to the entries of the directory in directory interface 770. Additionally, the capture logic 299 may be configured determine when the stored web pages are presenting and/or broadcasting content. This can be determined by analyzing the web page (and/or related web pages), receiving an indication from the website that provides the content, and/or via other techniques. Once this data is compiled, the directory in directory interface 770 may be provided to the user. Additionally, by selecting one or more of the entries, the capture logic 299 may launch a web browser to provide the content and/or the web page that provides the content to the user.

Additionally, one should note that in some embodiments, the directory interface 770 may be configured to provide listings of archived and/or captured content. As a nonlimiting example, such static content may be displayed according to a date the content was originally archived, a date the content is scheduled to be removed from archive, and/or via other organization.

FIG. 8 illustrates an exemplary embodiment of a web interface 870, illustrating use of a capture option 874, such as may be provided by the client device from FIG. 2. As illustrated in FIG. 8, the web interface 870 may be addressed to a web page and configured provide content 872 to a user. While the content in FIG. 8 is depicted as video content, audio content, image content, and/or data content may be provided to the user.

In addition, the web interface 870 may include a capture option 874 and an add to guide option 876. More specifically, by selecting the capture option 874, the capture logic 299 may be configured to capture at least a portion of the content on the web page. In at least one exemplary embodiment, by selecting the capture option 874, the content can be captured according to default options. If there is more than one piece of content on the web page, the capture logic 299 can, depending on the particular configuration, capture all content on the web page; capture content in the visible portion of the web page; capture according to a default setting; and/or provide a user option to select the desired content to capture.

Similarly, the add to guide option 876 may be configured to add the current web page to the directory interface 770 (FIG. 7) as an entry. More specifically, by selecting the add to guide option 876, an entry can be added to the directory in the directory interface 770 such that the content from the web page of FIG. 8 can be provided to the user for easily viewing and/or recording.

One should note that while exemplary embodiments disclosed herein refer to content that is provided via a web page, these are nonlimiting examples. More specifically, in at least one embodiment, the content may be provided via an instant messaging session, a voice over Internet protocol (VoIP) communication, over a local area network (LAN) network and/or via other techniques. Other embodiments are also contemplated.

FIG. 9 illustrates an exemplary embodiment of the web interface, further depicting one or more options for capturing content, similar to the diagram from FIG. 8. As illustrated in FIG. 9, the web interface 870 may be configured to launch a web options interface 970 in response to selection of the capture option 874. More specifically, the web options interface may include a recording type option 972 to determine whether the desired recording is a single recording or a series recording. Additionally, a destination option 974 may be configured for the user to determine the desired destination for the captured content. A recording time option 976 may be configured for the user to select a time to record the selected content.

More specifically, the recording time option may be configured to receive a current and/or future time for recording. Receiving a current recording time may signify that the content has been archived and that the data may be accessed at any time. Similarly, some embodiments may be configured such that a current recording may indicate archived content and/or broadcast content that happens to be currently broadcast.

Similarly, the recording time option 976 may include a sub-option 978 that is configured to facilitate the capture logic 299 to determine a time to begin recording. Also included is a conversion type option 980 for the user to select the format conversion to apply, if any. One should note that while only two conversion types are listed in FIG. 9 (and FIG. 5), this is a nonlimiting example, as more or fewer conversion formats may be presented to the user.

FIG. 10 illustrates an exemplary embodiment of a web interface, further depicting a time option interface 1070, similar to the diagram from FIG. 9. As illustrated in of FIG. 10, the time option interface 1070 may be provided in response to selection of the sub-option 978, from FIG. 9. More specifically, the time option interface 1070 may be configured to provide user options 1072, 1074, and 1076 to start and/or end recording of selected content based on a user-defined time, content-defined criteria, and user-defined criteria, respectively.

In operation, the user-defined time option 1072 may be configured to receive a user-designated start time and/or stop time. The user-designated start time and/or stop time may be based on a time of day and/or based on a time of the content play counter. Similarly, the content-defined criteria option 1074 may be configured to list one or more segments of the content. As a nonlimiting example, the content may include metadata (and/or other identifiers) to indicate to the capture logic 299 when one or more segments begin and/or end. By selecting a dropdown menu of option 1074, the user can view the determined segments and can select one or more for recording. Similarly, in some configurations, the capture logic 299 may be configured to analyze the content to determine one or more segments of the content for providing in the content-defined criteria option 1074.

Similarly, the user-defined criteria option 1076 may be configured for a user to input a keyword for a desired portion of the content. As a nonlimiting example, the user may input a criteria such as “top stories.” The capture logic 299 may be configured to analyze the content to determine whether a segment can be defined under the input criteria. If so, then the determined segment may be recorded. Upon selection of the determined recording time, the user may select a submit option 1078 to save the selected option.

FIG. 11 illustrates an exemplary embodiment of the web interface, further depicting progress interface 1170, similar to the diagram from FIG. 10. As illustrated in the nonlimiting example of FIG. 11, the progress interface 1170 may be configured to provide information related to the selected options during recording of content.

One should also note that upon recording and/or storage of content, the content logic 299 may be configured to facilitate presentation of the recorded data. More specifically, in at least one embodiment, the content may be converted to a desired format for display on a desired content playback application.

FIG. 12 illustrates an exemplary embodiment of a process that may be utilized for scheduling the capture of Internet data, such as in the network from FIG. 1. As illustrated in FIG. 12, the capture logic 299 may be configured to provide an interface to capture Internet data (block 1232). The capture logic 299 may also determine at least one setting for capturing the content (block 1234). The capture logic 299 may be configured to access the desired content (block 1236). The capture logic 299 may also be configured to determine digital media rights for the accessed content (block 1238). More specifically, in at least one exemplary embodiment, the content provider may or may not desire recording of the content being provided. In such configurations, the capture logic 299 may be configured to determine whether the content provider has specified whether recording is permitted or not. The content provider may include a copyright notice on the web page; include metadata indicating that the content is protected; provide anti-piracy algorithm that complies with the digital millennium copyright act (DMCA); and/or otherwise provide indication that the content provider does not approve of recording or viewing of the content. Similarly, the content provider may indicate that a portion of the content is provided, but one or more other portions are available for recording and/or viewing.

The capture logic 299 may capture the content according to the determined digital media rights. The capture logic 299 can then facilitate storage of the captured content at a predetermined location. As discussed above, the predetermined location may include a local data storage component, a network storage component, and/or elsewhere.

FIG. 13 illustrates an exemplary embodiment of a process that may be utilized for capturing Internet data via a web interface, similar to the diagram from FIG. 12. As illustrated in the nonlimiting example of FIG. 13, the client device 102 may be configured to provide a web interface to view internet data (block 1332). The client device 102 may be configured to receive a user request to view a particular web page (block 1334). The client device 102 may be configured to provide the requested web page (block 1336). The client device 102 may also determine whether the provided web page includes recordable content (block 1338).

In response to a determination of recordable content, the client device 102 may provide a capture option (block 1340). While, the capture option may be incorporated into a web browser, as illustrated in FIGS. 8-11; however, these are nonlimiting examples. More specifically, the capture option may be provided in any of a plurality of different manners.

Additionally, the client device 102 can receive a request to capture content (block 1342). The client device 102 can capture the content according to predetermined settings (block 1344). Further, depending on the particular configuration, the content can be stored, as discussed above. As also discussed above, some embodiments may be configured to determine digital media rights of the content provider.

FIG. 14 illustrates an exemplary embodiment of a process that may be utilized for scheduling a recording of Internet content, similar to the diagram from FIG. 13. As illustrated in the nonlimiting example of FIG. 14, the capture logic 299 can receive data related to scheduled Internet content (block 1432). The capture logic 299 can additionally provide at least a portion of the received Internet data as a schedule, the schedule including one or more content entries corresponding to the scheduled internet content (block 1434). The capture logic 299 can, in response to receiving a selection of at least one of the entries, schedule a recording of the corresponding Internet content (block 1436). The capture logic 299 can record the scheduled recording according to predetermined settings (block 1438).

The embodiments of the capture logic 299 disclosed herein can be implemented in hardware, software, firmware, or a combination thereof. At least one embodiment disclosed herein may be implemented in software and/or firmware that is stored in a memory and that is executed by a suitable instruction execution system. If implemented in hardware, one or more of the embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), afield programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

We claim:

1. A method comprising:
receiving data related to scheduled Internet content;
providing at least a portion of the received Internet data as a schedule, the schedule including one or more content listings corresponding to the scheduled Internet content; and
in response to receiving a selection of at least one of the listings, scheduling a recording of the corresponding Internet content.

2. The method of claim 1, further comprising recording the scheduled content.

3. The method of claim 1, further comprising determining at least one predetermined setting for the recording.

4. The method of claim 3, wherein the schedule is provided in response to selection of a web-based capture option.

5. A system comprising:
a memory component storing the following:
receiving logic configured to receive data related to scheduled Internet content;
providing logic configured to provide at least a portion of the received Internet data as a schedule, the schedule including one or more content listings corresponding to the scheduled Internet content; and
scheduling logic configured to, in response to receiving a selection of at least one of the listings, schedule a recording of the corresponding Internet content.

6. The system of claim 5, further comprising recording logic configured to record the scheduled content.

7. The system of claim 5, further comprising determining logic configured to determine at least one predetermined setting for the recording, wherein the schedule is provided in response to selection of a web-based capture option.

8. The system of claim 5, wherein the system is embodied in a computer-readable medium.

9. A system comprising:
means for receiving data related to scheduled Internet content;
means for providing at least a portion of the received Internet data as a schedule, the schedule including one or more content listings corresponding to the scheduled Internet content; and
means for, in response to receiving a selection of at least one of the listings, scheduling a recording of the corresponding Internet content.

10. The system of claim 5, further comprising means for recording the scheduled content.
